(19) United States
(12) Patent Application Publication
(10) Pub. No.: US 2026/0034002 A1
(43) Pub. Date: Feb. 5, 2026

(54) MOBILE STANDING FRAME

(71) Applicant: Jay JOHNSON, Saint Cloud, MN (US)

(72) Inventors: Jay JOHNSON, Saint Cloud, MN (US); Douglas LENZ, Victoria, MN (US)

(21) Appl. No.: 19/100,731

(22) PCT Filed: Aug. 21, 2023
(86) PCT No.: PCT/US2023/072575

§ 371 Date: Feb. 3, 2025

Related U.S. Application Data
(60) Provisional application No. 63/373,133, filed on Aug. 22, 2022.

(51) Int. Cl. A61G 5/14; A61G 5/04; A61G 5/12

(52) U.S. Cl. CPC A61G 5/14; A61G 5/045; A61G 5/128

(57) ABSTRACT

A mobile standing frame is described that is designed to raise a user from a seated into a standing position, and return the user back to a seated position. The mobile standing frame is provided with a number of unique features that improve the user experience when using the mobile standing frame. For example, the mobile standing frame can be provided with a number of easily accessible individual user adjustment features (i.e. manual adjustment control buttons) that allow easy adjustment of components of the mobile standing frame to accommodate the size of the user. The mobile standing frame also includes a slope sensor to automatically lower the frame of the mobile standing frame from a fully standing position based on the sensed slope of a surface that the mobile standing frame is traveling along.

### FIELD

This technical description relates to a mobile standing frame in which the mobile standing frame is able to automatically move a user between seated and standing positions.

### BACKGROUND

A number of mobile standing frame designs are known in the art. Examples include the mobile standing frames described in U.S. Pat. Nos. 6,231,067, 9,173,792, 10,525,784, 10,172,752, and 2021/0161742.

### SUMMARY

A mobile standing frame is described that is designed to raise a user from a seated into a standing position, and return the user back to a seated position. The mobile standing frame also has motor driven wheels for locomotion along the ground. The mobile standing frame is provided with a number of unique features that improve the user experience when using the mobile standing frame. For example, the mobile standing frame can be provided with a number of easily accessible individual user adjustment features (i.e. manual adjustment control elements) that allow easy adjustment of components of the mobile standing frame to accommodate the size of the user.

In addition, the mobile standing frame can be provided with a feature that prevents tipping of the mobile standing frame when traveling up or down a slope when the mobile standing frame is in the standing configuration. When the mobile standing frame is in the standing configuration and traveling on a slope (either an incline or a decline), a slope sensor, such as a gyroscope, will detect the slope and based on the detected slope the controller will adjust the mobile standing frame incrementally depending upon the angle of the incline or decline. For example, when traveling down a slope, the mobile standing frame will be lowered depending upon the angle of the decline. As the mobile standing frame transitions from the decline to flat ground, the controller will raise the mobile standing frame to the fully standing configuration. In addition, when the mobile standing frame lowers, thereby lowering the user, the foot plate of the mobile standing frame will transition forward to create a longer fulcrum and if the mobile standing frame does begin to tip forward, the foot plate will be out front of the mobile standing frame far enough to prevent tipping. In an embodiment, a single actuator motor raises and lowers the mobile standing frame, and also acts as the motor that controls the movement of the foot plate to prevent tipping.

In addition, the mobile standing frame has a center of mass that has a horizontal or lateral position that is behind the axes of the front wheels (i.e. between the axes of the front wheels and the axes of the rear wheels) in both the sitting and standing configurations when viewing the mobile standing frame from the side. In addition, the center of mass has a vertical position in the side view that is lower than conventional mobile standing frames in both the sitting and standing configurations. For example, the center of mass is about 15.5 inches or less above the ground when in the standing configuration, and about 11.5 inches or less above the ground when in the sitting configuration.

### DRAWINGS

FIG. 1 is a perspective view of a mobile standing frame described herein with the mobile standing frame in a seated configuration.

FIG. 2 is another perspective view of the mobile standing frame of FIG. 1 with the mobile standing frame in a fully raised, standing configuration.

FIG. 3 is another perspective view of the mobile standing frame of FIGS. 1 and 2 with the mobile standing frame in an intermediate position between the seated configuration and the fully raised, standing configuration.

FIG. 4 is another perspective view of the mobile standing frame illustrating details of the drive mechanism for actuating the mobile standing frame between the seated configuration and the standing configuration.

FIG. 5 is a side view of the frame of the mobile standing frame showing major components of the frame.

FIG. 6 schematically depicts a control system of the mobile standing frame described herein.

FIG. 7 illustrates an example of a method for controlling the position of the mobile standing frame based on slope angle.

FIG. 8 is a side view of the mobile standing frame in the fully raised, standing configuration.

FIG. 9 is a detailed view of the knee brace of the mobile standing frame showing additional individual user adjustment features.

FIG. 10 is a top view of the mobile standing frame in the seated configuration showing additional individual user adjustment features.

FIG. 11 is a perspective view of the mobile standing frame with the foot plate removed to show support wheels that support one side of the foot plate.

FIG. 12 is a side view of the mobile standing frame in the seated configuration showing the center of mass of the mobile standing frame in the seated configuration.

FIG. 13 is a side view of the mobile standing frame in the fully raised, standing configuration showing the center of mass of the mobile standing frame in the standing configuration.

### DETAILED DESCRIPTION

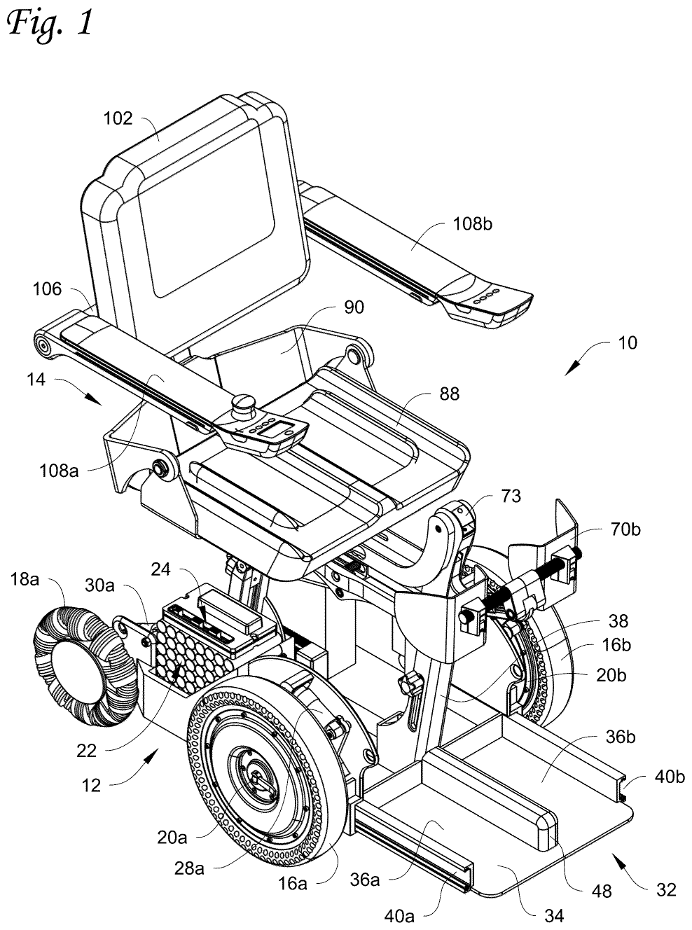

Referring to FIGS. 1-4, an example of a mobile standing frame 10 is depicted. The mobile standing frame 10 is designed to be driven while the user is standing, with self-balancing sensors to prevent tipping when in motion while standing.

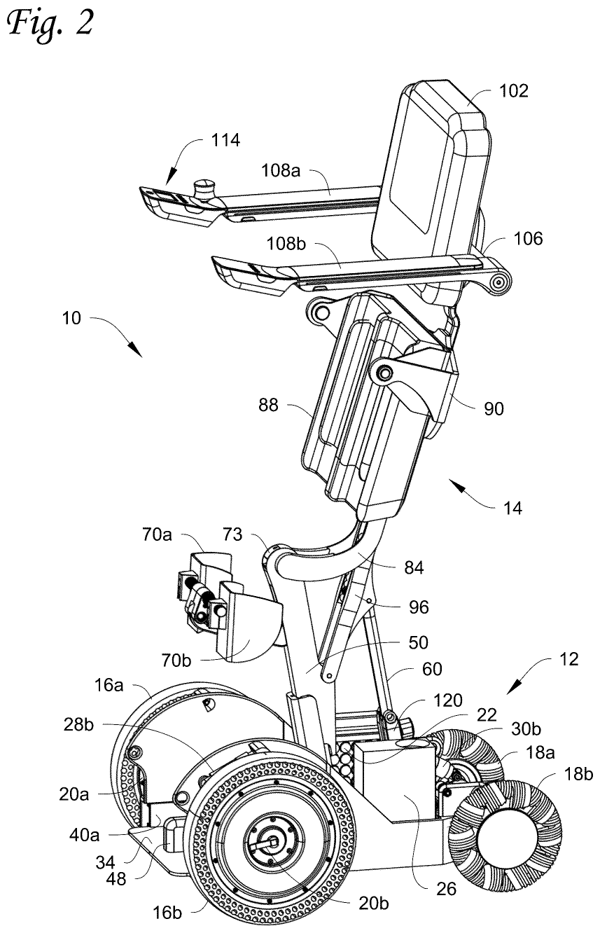

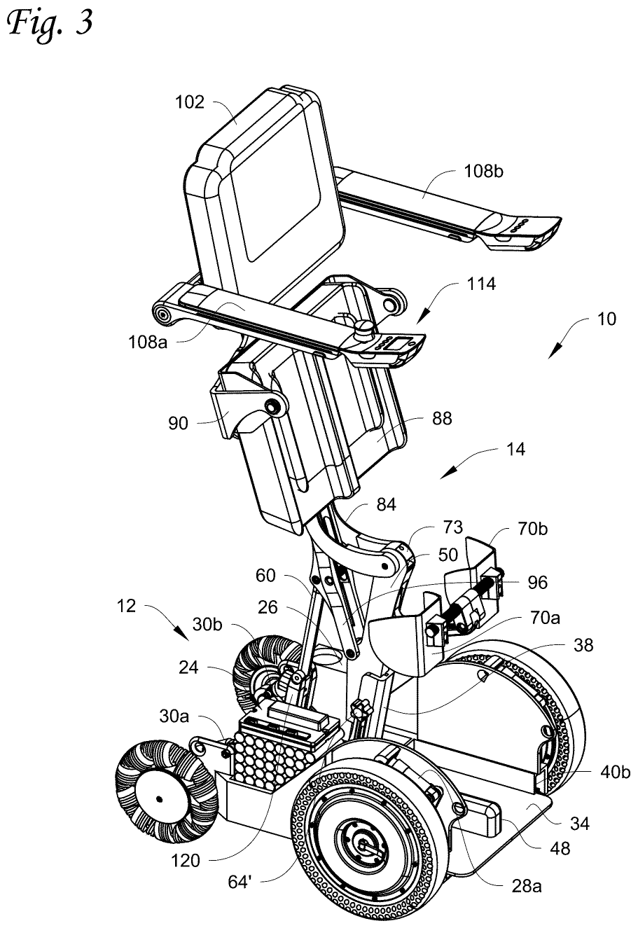

The mobile standing frame 10 generally includes a chassis or base 12 and a frame 14 that is mounted on the chassis 12. The frame 14 is mounted on the chassis 12 so as to be actuatable relative to the chassis 12 between a seated configuration (FIG. 1) where a user (not shown) is in a seated position and a standing configuration (FIG. 2) where the user is in a standing position, and intermediate configurations (one of which is shown in FIG. 3) between the seated configuration and the standing configuration where the user is between the seated position and the standing position.

The chassis 12 has a generally rigid, rectangular structure defining a front end, a rear end, a right side and a left side. The terms right and left are from the perspective of a user occupying the mobile standing frame 10. The chassis 12 has wheels 16a, 16b, 18a, 18b that support the chassis 12 for rolling movement along the ground. The wheels 16a, 16b, which may be referred to as front wheels, are driven wheels that are driven by one or more electric wheel drive motors. For example, the wheels 16a, 16b can be driven by respective wheel drive motors, such as electric hub drive motors 20a, 20b incorporated in the wheels 16a, 16b for locomotion of the mobile standing frame 10 along the ground. The general construction and operation of hub drive motors is known in the art. The hub drive motors 20a, 20b may be brushless DC hub motors each with an internal electromagnetic brake and a manual release so the motors can be disengaged to allow the mobile standing frame 10 to roll freely. The tires of the wheels 16a, 16b may be porous and vibration suppressing.

The wheels 18a, 18b may be referred to as rear wheels and are not driven by motors. Preferably, the wheels 18a, 18b are configured to permit rolling movement forward, backward and laterally. For example, the wheels 18a, 18b may be omnidirectional wheels (or omni-wheels).

Power for powering the mobile standing frame 10 can be provided from one or more batteries 22 mounted on the chassis 12. The battery 22 can be rechargeable or non-rechargeable. The battery 22 can be a lithium battery, such as a plurality of Tesla 21700 lithium battery cells. The chassis 12 can further include a control module 24, and a power supply 26 that regulates the power from the battery 22 for use by the various electrical components of the mobile standing frame 10.

The mobile standing frame 10 has 4-wheel independent suspension including individual shock absorbers 28a, 28b supporting the wheels 16a, 16b and individual shock absorbers 30a, 30b supporting the wheels 18a, 18b.

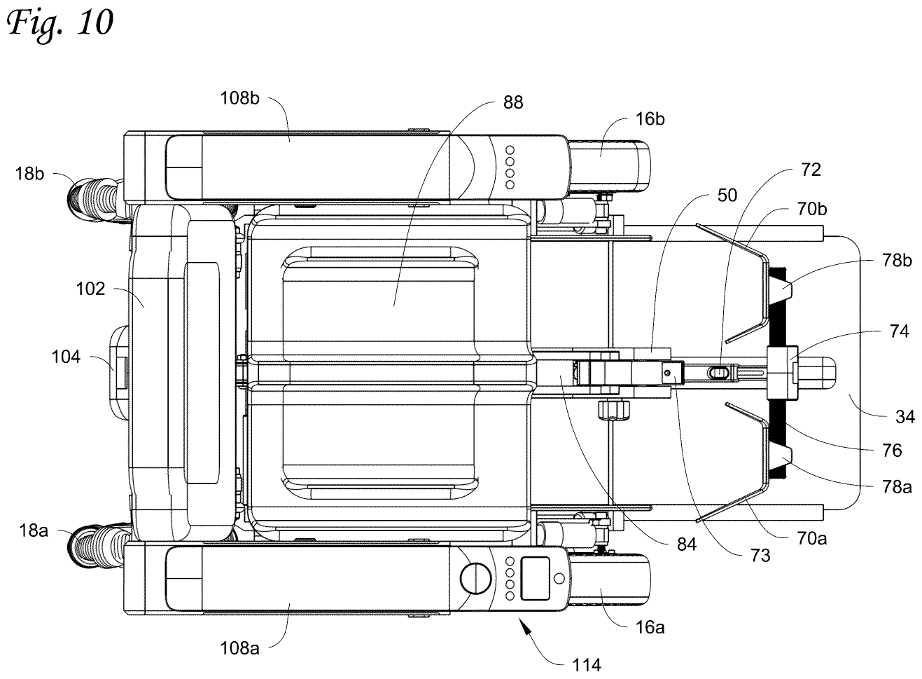

A foot plate assembly 32 is movably supported on the chassis 12. The foot plate assembly 32 moves back and forth relative to the chassis 12 as the mobile standing frame 10 moves between the seated configuration and the standing configuration. The foot plate assembly 32 includes a foot plate 34 defining regions 36a, 36b for placing the user's feet during use, and a column receiver 38 that projects upwardly from the center rear of the foot plate 34. The foot plate 34 includes a pair of channels 40a, 40b on the sides thereof that receive support wheels 42 (FIG. 10) mounted on each side of the chassis 12 that rollingly support the foot plate assembly 32 as it moves back and forth. Only one set of the support wheels 42 is visible in FIG. 10; another set of the support wheels 42 will be located on the opposite side of the chassis 12 within the channel 40b. As best seen in FIGS. 1 and 2, the foot plate assembly 32 is movable between a forward position (FIG. 1) when the mobile standing frame 10 is in the seated configuration, and a rear position (FIG. 2) when the mobile standing frame 10 is in the standing configuration. In addition, the vertical height of the foot plate 34 does not change and the foot plate 34 remains below the axes of the front wheels 16a, 16b in the seated configuration and in the standing configuration. For example, the foot plate 34 may be about 2.0 inch above the ground in the seated configuration and in the standing configuration.

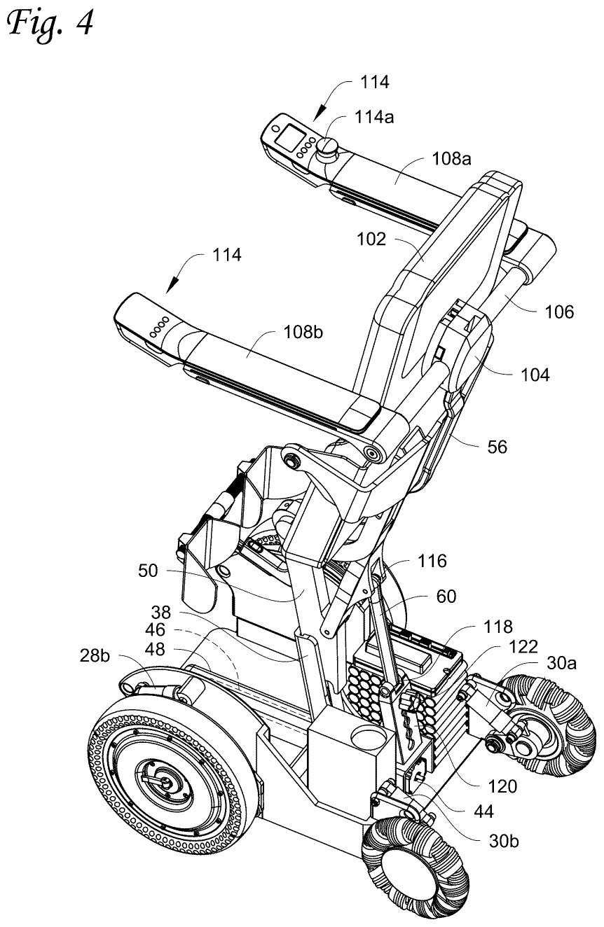

With reference to FIGS. 1-4, the movement of the foot plate assembly 32 actuates the frame 14 so that the frame 14 transitions up-and-back while being actuated to the standing configuration to enhance stability and transitions down-and-forward while being actuated to the seated configuration to make motion control intuitive and natural. Referring to FIG. 4, the foot plate assembly 32 is driven forward and backward by a drive motor 44 mounted on the chassis 12. The drive motor 44 drives a screw shaft 46 that extends into a channel 48 formed on the foot plate assembly 32. A rubber bellows or a metal barrier can surround some or all of the screw shaft 46 to protect the screw shaft 46 and conceal it. A nut (not shown) is fixed in the channel 48 so that rotation of the screw shaft 46 drives the nut forward and backward (depending upon the direction of rotation of the output shaft of the drive motor 44, thereby driving the foot plate assembly 32 forward and backward which raises and lowers the frame 14. So the raising and lowering of the mobile standing frame 10 is achieved using the single drive motor 44.

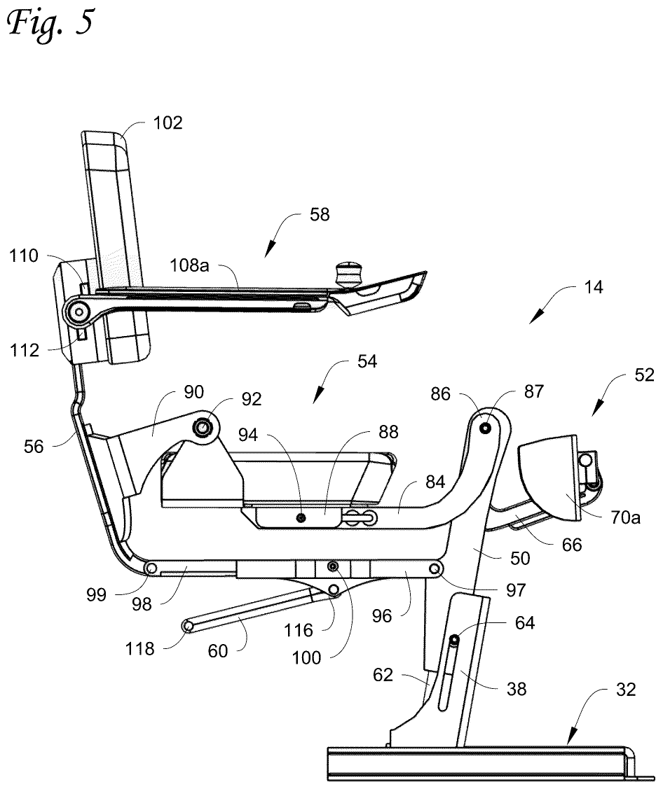

Referring to FIGS. 1-5, the frame 14 comprises a column 50, a knee brace assembly 52, a seat assembly 54, a spine 56, an arm rest assembly 58, and a ram rod 60. The column 50 is disposed in and adjustably fixed to the column receiver 38. A gas spring 62 interconnects the column 50 with the chassis 12 to allow manual user adjustment of the height of the column 50 via a manual adjustment control button 64 that is accessible at the side of the column receiver 38. As best seen in FIG. 5, the column receiver 38 and the column 50 are both angled forward. As the column 50 rises it moves the location of pivot 87 forward so that the center of mass can remain in the center of the chassis

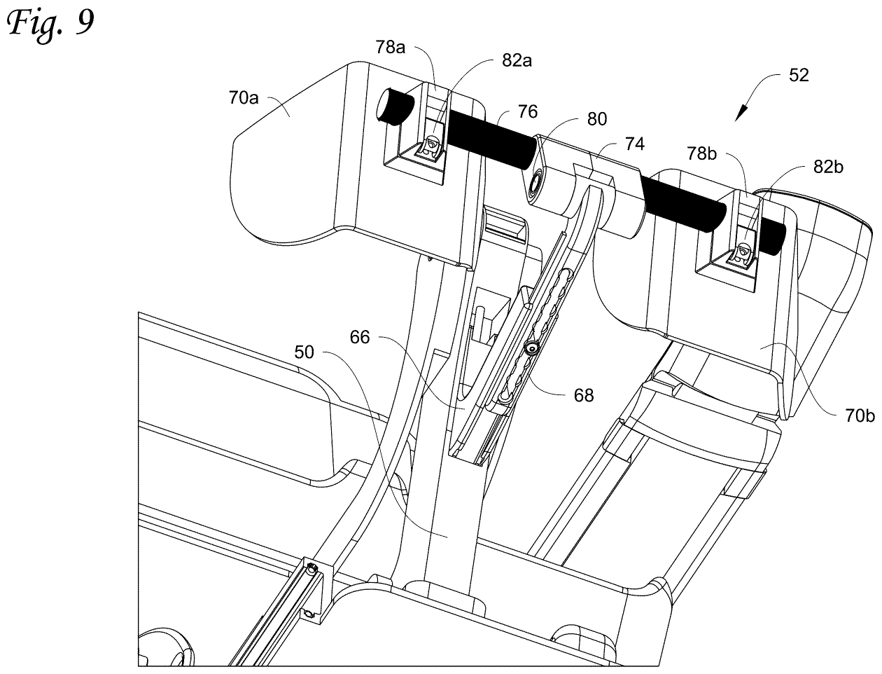

The knee brace assembly 52 is mounted at an upper end of the column 50. Referring to FIGS. 5, 9 and 10, the knee brace assembly 52 includes a knee brace base 66 fixed to the column 50. A slide bar 68 is slideably disposed on the base 66 and is adjustably moveable relative to the base 66 to extend and retract knee braces 70a, 70b mounted at the end of the slide bar 68. A manual adjustment control button 72 is accessible on the base 66. By pressing down on the button 72, the slide bar 68 can be incrementally slid in or out relative to the base 66. When the button 72 is released, a spring (not shown) biases the button 72 to a locked position which locks the position of the slide bar 68. In addition, a manual adjustment control lever 73 (which may be referred to as a knee brace release lever) is provided at the top end of the column 50 (as best seen in FIGS. 1, 3 and 10). When the lever 73 is actuated, the knee brace assembly 52 is released and can be removed from the mobile standing frame 10.

With continued reference to FIGS. 5, 9 and 10, a yoke 74 is adjustably mounted at the end of the slide bar 68, and a rod 76 extends through the yoke 74. The outer surface of the rod 76 may be roughened, for example knurled, and knee brace clamps 78a, 78b are mounted on the knee braces 70a, 70b. A manual adjustment control button 80 is provided on the yoke 74 that when pressed allows the yoke 74 to pivot relative to the slide bar 68 to move the knee braces 70a, 70b closer or further away from the user. When the control button 80 is released, the position of the yoke 74 is locked until the button 80 is pressed again. In addition, the knee brace clamps 78a, 78b are configured as cam locks with manual adjustment control levers 82a, 82b. The levers 82a, 82b can be individually actuated to release clamping on the rod 76, allowing each knee brace 70a, 70b to rotate relative to the rod 76 about the axis of the rod 76, as well as allow the positions of the knee braces 70a, 70b to be laterally adjusted along the length of the rod 76. Once the desired positions of the knee braces 70a, 70b are reached, the levers 82a, 82b can then be rotated to lock the clamps 78a, 78b to fix the positions of the knee braces 70a, 70b.

Returning to FIGS. 1-5, the seat assembly 54 comprises a seat rail 84 having a front end 86 that is pivotally attached to the upper end of the column 50 at pivot 87 to allow the seat rail 84 to pivot relative to the column 50. A seat pan 88 is movably secured to the seat rail 84 to allow adjustment of the position of the seat pan 88 relative to the seat rail 84. The seat pan 88 is also pivotally attached to a girdle 90 at a pivot 92 that is fixed to the spine 56. A manual adjustment control button 94 is provided on the seat pan 88 that allows adjustment of the depth of the seat pan 88 along the seat rail 84 by pressing the button 94. When the button 94 is released, the position of the seat pan 88 is locked.

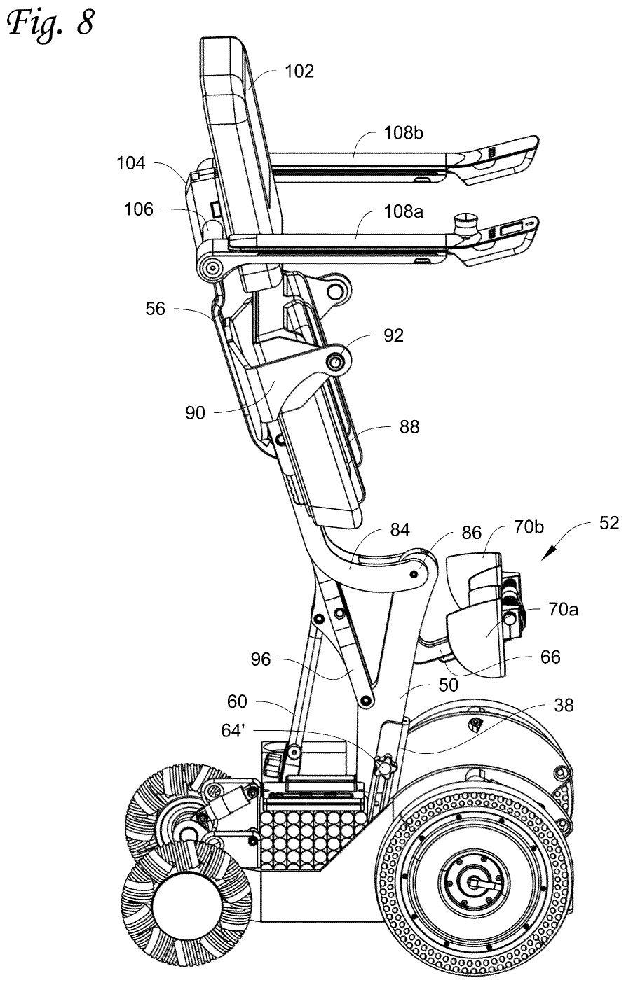

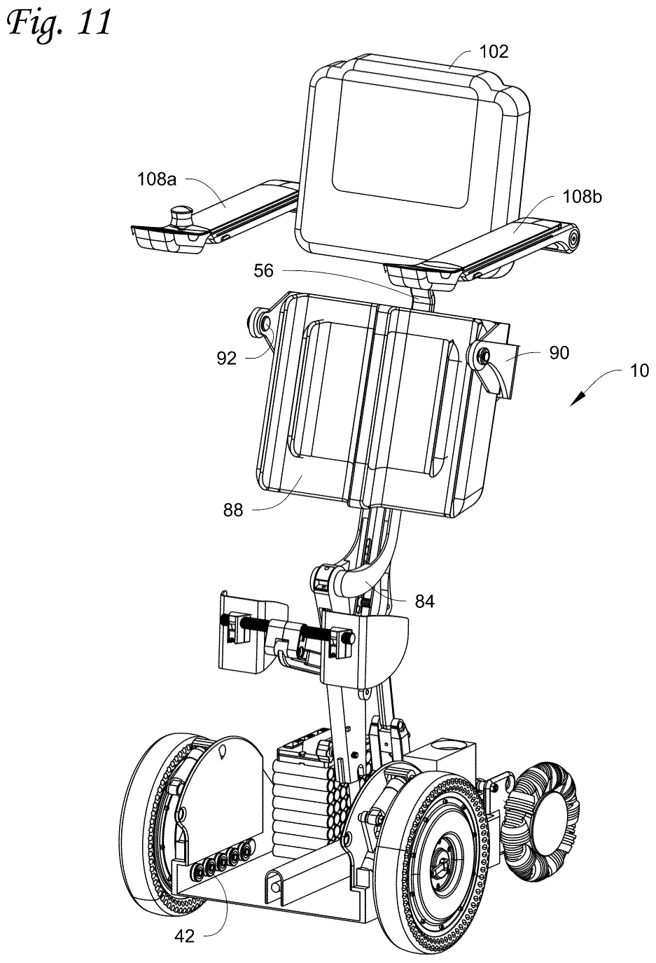

The spine 56 is connected to the column 50 by a backrest link 96 and a backrest extender 98 that is adjustably mounted on the backrest link 96. The backrest link 96 is pivotally attached to the column 50 at pivot 97, and the backrest extender 98 is pivotally attached to the spine 56 at pivot 99. A manual adjustment control button 100 is provided on the backrest link 96 that allows adjustment of the backrest extender 98 relative to the backrest link 96 by pressing the button 100. When the button 100 is released, the position of the backrest extender 98 is locked. As best seen in FIGS. 3, 8, 11 and 13, the seat rail 84 comprises a pair of spaced members, and in the standing configuration, the backrest link 96 recesses into the seat rail 84 between the two spaced members. In addition, the brace 66 recesses into the column 50.

A backrest 102 is secured to an upper end of the spine 56 via a bracket 104 that is adjustably mounted on the spine 56. In addition, a rod 106 extends laterally through the bracket 104, and arm rests 108a, 108b of the arm rest assembly 58 are mounted at the ends of the rod 106. A manual adjustment control button 110 is provided on the bracket 104 that allows adjustment of the height of the backrest 102 relative to the bracket 104. When the button 110 is released, the position of the backrest 102 is locked. In addition, another manual adjustment control button 112 is provided on the bracket 104. The button 112, when pressed, allows adjustment of the location of the bracket 104 along the spine 56, thereby adjusting the height of the arm rests 108a, 108b. When the button 110 is released, the position of the bracket 104 is locked.

As best seen in FIG. 4, various mobile standing frame controls 114 (or arm rest controls 114) can be provided on one or both of the arm rests 108a, 108b. The controls 114 can be buttons, levers, control knobs, a joystick, a touch screen, and other control elements for controlling operation of the mobile standing frame 10 such as forward, backward, and side movements, raising and lowering the mobile standing frame 10, and other control operations. In one embodiment, the controls 114 can include a joystick 114a. In another embodiment, the controls 114 can be interchangeable from the right armrest 108a to the left armrest 108b.

Returning to FIGS. 1-5, the ram rod 60 is pivotally connected at one end 116 thereof to the backrest link 96 and fixed at its opposite end 118 to a raised portion 120 of the chassis 12. The end 118 of the ram rod 60 is adjustably connected to the raised portion 120 to allow the position of the end 118 to be adjusted up or down relative to the raised portion 120. A manual adjustment control button 122 is provided that when pressed allows adjustment of the height of the ram rod 60 by altering the location of the end 118 relative to the raised portion 120. When the button 122 is released, the height of the ram rod 60 is fixed to the raised portion 120 locking the position of the end 118 of the ram rod 60.

In all of the manual adjustment control features described herein, the adjustment can be achieved using manual buttons (like the buttons 64, 72, 80, 94, 100, 110, 112, 122 depicted in FIGS. 1-5), or using adjustment knobs (like the knob 64′ visible in FIGS. 3 and 12-13).

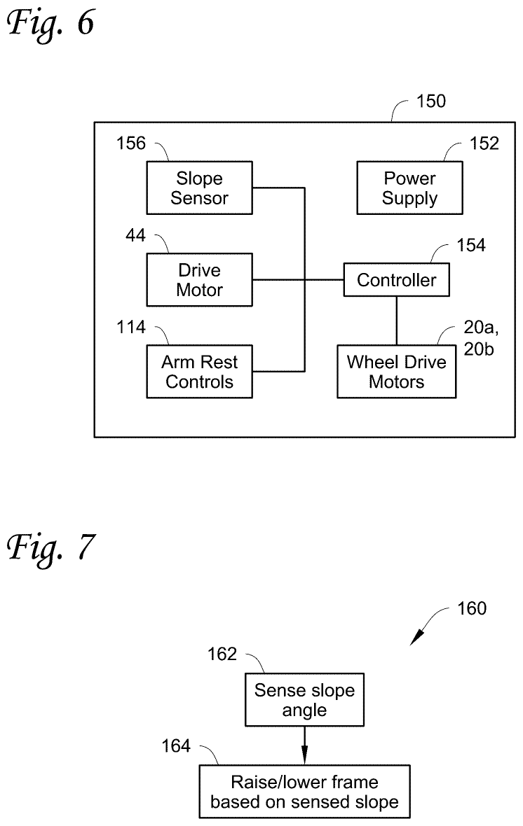

Referring to FIG. 6, the mobile standing frame 10 includes a control system 150 that controls operation of the mobile standing frame 10. The control system 150 includes a power supply 152, such as the battery 22, that provides electrical power, and a controller 154 that is electrically connected to the wheel drive motors 20a, 20b, the drive motor 44, and the arm rest controls 114. The controller 154 controls the operation of the wheel drive motors 20a, 20b and the drive motor 44, for example based on control inputs input via the arm rest controls 114, to control forward, reverse and/or side movements of the mobile standing frame 10, and actuate the mobile standing frame 10 between the sitting and standing configurations via the drive motor 44 and the screw shaft 46 as described above.

The control system 150 further includes a slope sensor 156 that is connected to the controller 154. The slope sensor 156 is part of an automatic control system of the mobile standing frame 10 whereby the controller 154 automatically adjusts the standing height of the mobile standing chair 10 based on the sensed slope angle. The slope sensor 156 can have any configuration that is suitable for sensing a slope of the surface along which the mobile standing frame 10 is traveling. For example, the slope sensor 156 can be a gyroscope, an accelerometer, or any other type of tilt sensor.

Referring to FIG. 6 along with FIG. 7 which depicts an auto control method 160, when the mobile standing frame 10 is in the standing configuration and traveling on a slope (either an incline or a decline), the slope sensor 156 will detect the slope at 162 and based on the detected slope the controller 154 will automatically adjust the frame 14 incrementally (either up or down) at 164 depending upon the angle of the incline or decline. For example, when traveling down a slope, the frame 14 will be automatically lowered to a lowered or intermediate standing configuration depending upon the angle of the decline that is detected by the slope sensor 156. As the mobile standing frame 10 transitions from the decline to flat ground, the controller 154 will automatically raise the frame 14 back to the fully standing configuration. In addition, when the frame 14 lowers, thereby lowering the user, the foot plate 34 will transition forward to create a longer fulcrum and if the mobile standing frame 10 does begin to tip forward, the foot plate 34 will be out front of the mobile standing frame 10 (for example, see FIG. 3) far enough to prevent forward tipping.

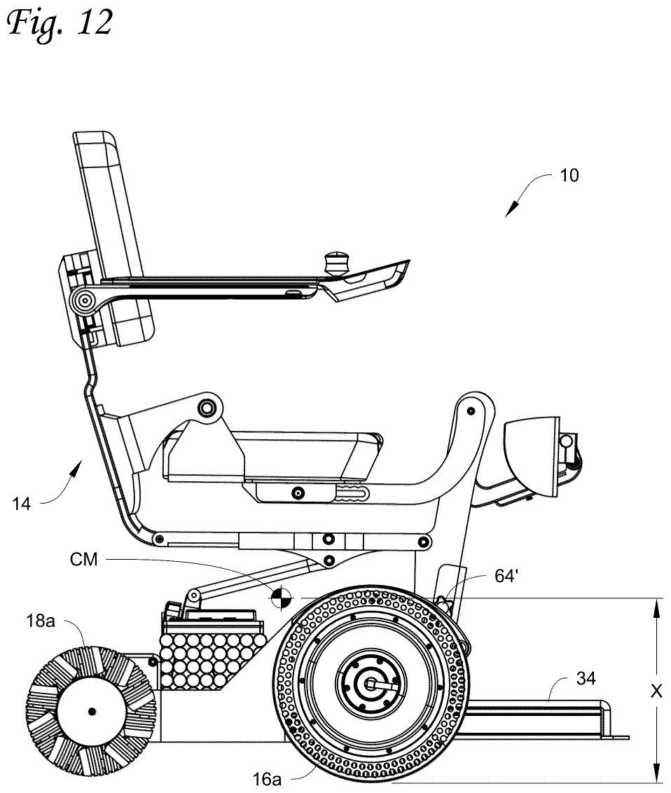

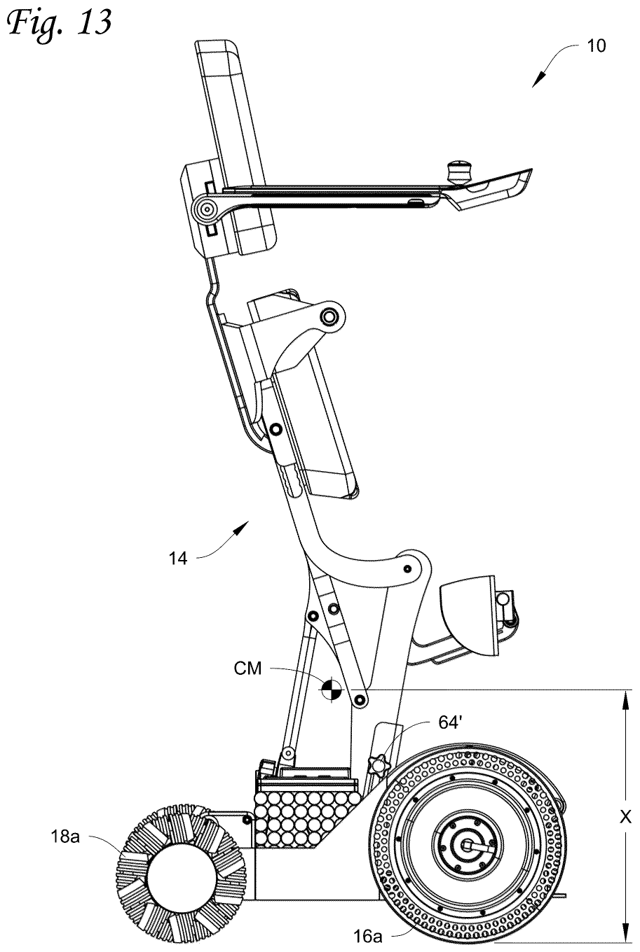

Referring to FIGS. 12 and 13, the mobile standing frame 10 is also unique in that it has a center of mass CM that is lower in both the sitting configuration and the standing configuration compared to conventional mobile standing frames. In particular, in a side view, the center of mass CM has a horizontal or lateral position that is behind the axes of the front wheels 16a, 16b but forward of the rear wheels 18a, 18b (i.e. the CM is between the axes of the front wheels 16a, 16b and the axes of the rear wheels 18a, 18b) in both the sitting and standing configurations. In addition, the center of mass CM has a vertical distance X above the ground in the side view that is lower than conventional mobile standing frames in both the sitting and standing configuration. For example, in one embodiment, the center of mass CM is a distance X about 15.5 inches or less above the ground when in the standing configuration (as shown in FIG. 13), and a distance X of about 11.5 inches or less above the ground when in the sitting configuration (as shown in FIG. 12).

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A mobile standing frame, comprising:
a chassis having wheels that support the chassis for rolling movement along the ground;
a wheel drive motor in driving engagement with one or more of the wheels for driving the one or more wheels;
a frame mounted on the chassis, the frame is actuatable relative to the chassis between a seated configuration and a standing configuration;
a frame drive motor engaged with the frame for driving the frame between the seated configuration and the standing configuration;
and one or more of the following:
a) a control system in communication with the frame drive motor, the control system includes a slope sensor that senses a slope angle of a surface on which the mobile standing frame is traveling, and a controller in communication with the slope sensor and the frame drive motor that controls the frame drive motor based on a slope angle sensed by the slope sensor;
b) a plurality of manual adjustment control elements on the frame that adjust components of the frame to a user.

2. The mobile standing frame of claim 1, comprising a).

3. The mobile standing frame of claim 1, comprising b). The mobile standing frame of claim 1, comprising a) and b).

5. The mobile standing frame of claim 1, further comprising a foot plate assembly having a foot plate, the foot plate is movably supported on the chassis for movement between a forward position when the frame is in the seated configuration and a rear position when the frame is in the standing configuration; and the foot plate is configured such that when the frame is lowered from the standing configuration toward the seated configuration, the foot plate moves forward to create a longer fulcrum and the foot plate projects forwardly of the mobile standing frame at the seated configuration a sufficient distance to prevent tipping of the mobile standing frame.

6. The mobile standing frame of claim 5, wherein the frame drive motor is engaged with the foot plate to drive the foot plate between the forward position and the rear position.

7. The mobile standing frame of claim 5, wherein the wheels include front wheels, and the foot plate is disposed below axes of the front wheels.

8. The mobile standing frame of claim 1, wherein the components adjusted by the manual adjustment control elements comprise a gas spring of the frame, a knee brace assembly, a seat pan, and a backrest.

9. A method of controlling the mobile standing frame of claim 1, comprising:
with the frame in the standing configuration, sensing a slope angle of a surface on which the mobile standing frame is traveling;
based on the sensed slope angle, automatically lowering the frame of the mobile standing frame toward the seated configuration.

10. The method of claim 9, further comprising automatically raising the frame toward the standing configuration as the mobile standing frame transitions to flat ground.

11. The method of claim 9, further comprising actuating a foot plate of a foot plate assembly toward a forward position as the mobile standing frame is automatically lowered toward the seated configuration.
